(19) United States
(12) Patent Application Publication
(10) Pub. No.: US 2012/0317230 A1
(43) Pub. Date: Dec. 13, 2012

(54) NETWORK APPARATUS, TRANSMISSION DESTINATION INQUIRING METHOD, AND NON-TRANSITORY COMPUTER READABLE STORAGE MEDIUM

(75) Inventors: Takahiro SHIRAKAWA, Yokohama (JP); Daisuke HAMA, Kawasaki (JP); Takeshi ADACHI, Kawasaki (JP); Jun HASEGAWA, Akashi (JP); Takahiro KOHARAGI, Tokyo (JP); Takuji FURUSAWA, Tokyo (JP); Hiroaki KAWASUMI, Tokyo (JP); Masaharu NOZAWA, Shizuoka (JP); Katsumi KOBAYASHI, Tokyo (JP)

(73) Assignee: FUJITSU LIMITED, Kawasaki-shi (JP)

(21) Appl. No.: 13/490,952

(22) Filed: Jun. 7, 2012

(30) Foreign Application Priority Data
Jun. 10, 2011 (JP) 2011-130546

(51) Int. Cl. G06F 15/16

(52) U.S. Cl. 709/217

(57) ABSTRACT

A network apparatus includes a learning table that stores transmission destination information, which is used in transmitting a frame to a node, in association with an address of a node of a transmission destination, an address inquiring unit that transmits, when detecting a frame indicating a transmission request and transmission destination information associated with an address of a transmission destination of the detected frame is not stored in the storing unit, an inquiry request for the transmission destination information to an adjacent node, the inquiry request being added with a predetermined number of hops indicating a number of nodes to which the inquiring request is transmitted, and a frame transmitting unit that transmits, based on response information to the inquiry request, the frame indicating the transmission request.

### CROSS-REFERENCE TO RELATED APPLICATION

This application is based upon and claims the benefit of priority of the prior Japanese Patent Application No. 2011-130546, filed on Jun. 10, 2011, the entire contents of which are incorporated herein by reference.

### FIELD

The embodiment discussed herein is directed to a network apparatus and the like.

### BACKGROUND

Some relay apparatus such as a network switch or a wireless ad-hoc has a learning function concerning an address (an MAC address) used in a data link layer (a layer 2). Such a relay apparatus transmits a frame, which a user desires to transmit, to a physical line in which an address of a transmission destination of the frame is present. However, if it is unknown in which physical line the address of the transmission destination is present, the relay apparatus transfers the frame to all physical lines connected to the relay apparatus. This is called “flooding”.

A technology for inquiring about an address of a transmission destination is explained. In this technology, to inquire about an address of a transmission destination, a radio station exchanges, using an inquiry frame and a response frame, routing information for relaying a frame with a radio station adjacent to the radio station. The radio station detects, according to the exchanged information, a radio station not included in a learning table of the radio station but included in a learning table of the adjacent radio station. As a result, if the detected radio station coincides with the address of the transmission destination, the radio station can relay the frame to the radio station in the address of the transmission destination via the adjacent radio station.

In another technology, if an address coinciding with a transmission destination address of a received frame is not registered in a learning table, a relay apparatus inquires all relay apparatuses connected to the relay apparatus whether the address coinciding with the transmission destination address is registered. When the relay apparatus receives a response frame transmitted from a relay apparatus determined as already registered, the relay apparatus relays the received frame via a reception port of the response frame.

As documents that disclose the related art, there are Japanese Laid-open Patent Publication No. 2006-319676 and Japanese Laid-open Patent Publication No. 2009-200632.

However, in communication in the layer 2, when a relay apparatus, an address of a transmission destination of which is not learned, inquires about the address of the transmission destination, unnecessary traffic occurs and security may be unable to be maintained. Specifically, when the relay apparatus performs flooding, the relay apparatus transfers a frame to all physical lines connected to the relay apparatus. Therefore, unnecessary traffic occurs. As a result, likelihood of wiretapping due to packet capture increases.

In the technology for exchanging the routing information with the adjacent radio station, the radio stations communicate the routing information with each other with the learning tables of the radio stations attached to the routing information. Therefore, unnecessary traffic occurs. Moreover, if the adjacent radio station does not know the address of the transmission destination, the radio station may be unable to relay the frame to the address of the transmission destination via the adjacent radio station. In the technology for inquiring all the connected relay apparatuses about a transmission destination address, unless the transmission destination address is registered in all the relay apparatuses, the relay apparatus at the inquiry source may be unable to relay the received frame.

### SUMMARY

According to an aspect of an embodiment of the invention, a network apparatus includes a storing unit, an inquiring unit and a transmitting unit. The storing unit stores transmission destination information, which is used in transmitting a frame to a node, in association with an address of a node of a transmission destination. The inquiring unit transmits, when detecting a frame indicating a transmission request and transmission destination information associated with an address of a transmission destination of the detected frame is not stored in the storing unit, an inquiry request for the transmission destination information to an adjacent node, the inquiry request being added with a predetermined number of hops indicating a number of nodes to which the inquiring request is transmitted. The transmitting unit transmits, based on response information to the inquiry request, the frame indicating the transmission request.

The object and advantages of the embodiment will be realized and attained by means of the elements and combinations particularly pointed out in the claims.

It is to be understood that both the foregoing general description and the following detailed description are exemplary and explanatory and are not restrictive of the embodiment, as claimed.

### BRIEF DESCRIPTION OF DRAWINGS

FIG. 1 is a functional block diagram illustrating the configuration of a network system according to an embodiment;

FIG. 2 is a diagram illustrating an example of a data structure of a learning table;

FIG. 3 is a diagram illustrating an example of a data structure of an inquiry management table;

FIG. 4A is a diagram illustrating an example of a format of an inquiry frame;

FIG. 4B is a diagram illustrating an example of a format of a response frame;

FIG. 5 is a flowchart for explaining a procedure of address inquiry (an inquiry source) according to the embodiment;

FIG. 6 is a flowchart for explaining a procedure of address inquiry (an inquiry destination) according to the embodiment;

FIG. 7A is a diagram for explaining a specific example of a frame flow of a frame exchanged when the number of hops is 1;

FIG. 7B is a diagram for explaining a specific example of a frame flow of a frame exchanged when the number of hops is 2;

FIG. 8 is a diagram for explaining a sequence of communication performed when the address inquiry according to the embodiment is used for an HT; and

FIG. 9 is a diagram illustrating a computer that executes a transmission destination inquiry program.

### DESCRIPTION OF EMBODIMENT

Preferred embodiments of the present invention will be explained with reference to accompanying drawings. In an embodiment explained below, the present invention is applied to a network apparatus that performs communication control in a data link layer (a layer 2) using an Ethernet (registered trademark). The present invention is not limited by the embodiment.

Configuration of a network system according to the embodiment

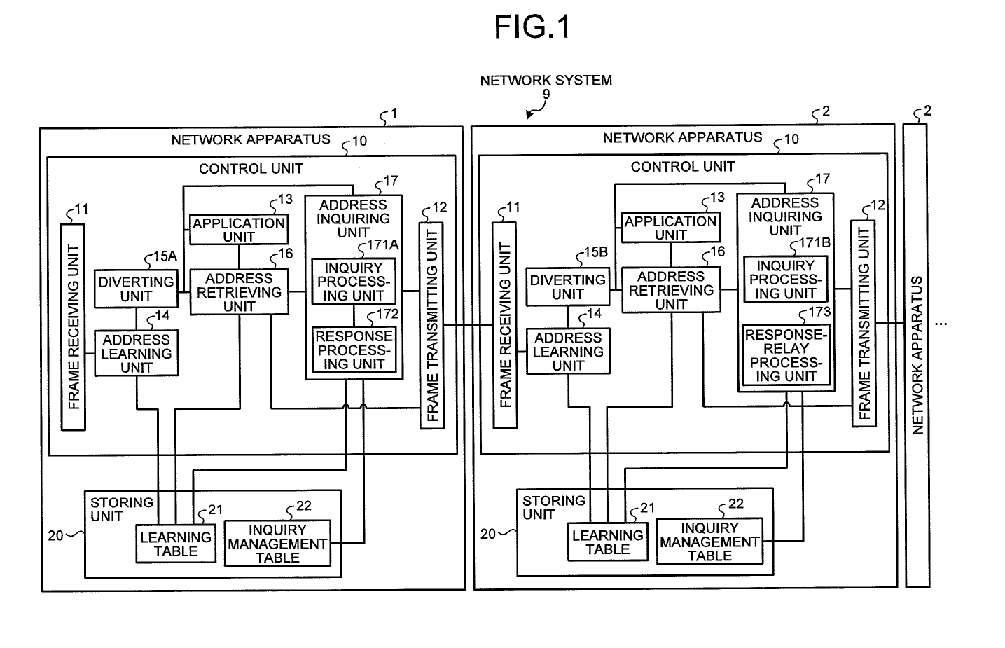

FIG. 1 is a functional block diagram illustrating the configuration of a network system according to the embodiment. As illustrated in FIG. 1, a network system 9 includes a network apparatus 1 and n network apparatuses 2. The network apparatus 1 is directly connected to the n network apparatuses 2 or indirectly connected to the n network apparatuses 2 via a transmission line in a network. A connection method can be either connection by wire or connection by radio. In the following explanation, it is assumed that the network apparatus 1 and the n network apparatuses 2 are connected by wire. The network apparatuses 1 and 2 perform communication in the layer 2 for identifying a transmission destination using an MAC address.

Configuration of the Network Apparatus 1

When the network apparatus 1 detects a frame indicating a transmission request, if transmission destination of a transmission destination of the frame is not learned by the network apparatus 1, the network apparatus 1 transmits an inquiry request for inquiring about the transmission destination information of the transmission destination to the network apparatus 2 adjacent to the network apparatus 1. Such an inquiry request includes the number of apparatuses that the network apparatus 2 inquires about the transmission destination information of the transmission destination (hereinafter referred to as “number of hops”).

The configuration of the network apparatus 1 is explained. The network apparatus 1 includes a control unit 10 and a storing unit 20. The control unit 10 is an integrated circuit such as an application specific integrated circuit (ASIC) or a field programmable gate array (FPGA) or an electronic circuit such as a central processing unit (CPU) or a micro processing unit (MPU). Further, the control unit 10 includes a frame receiving unit 11, a frame transmitting unit 12, an application unit 13, an address learning unit 14, a diverting unit 15A, an address retrieving unit 16, and an address inquiring unit 17.

The storing unit 20 is a semiconductor memory device such as a random access memory (RAM) or a flash memory or a storage device such as a hard disk or an optical disk. Further, the storing unit 20 includes a learning table 21 and an inquiry management table 22.

The frame receiving unit 11 receives, from a transmission line, for example, a frame indicating a transmission request or a relay frame for relaying the frame. The frame receiving unit 11 receives, from the network apparatus 2, a response to an inquiry request for inquiring about transmission destination information of a transmission destination related to the transmission request.

The frame transmitting unit 12 transmits various frames to the transmission line.

The application unit 13 executes an application. For example, the application unit 13 executes an application for generating a transmission request to the network apparatus 2.

The address learning unit 14 learns an address of a transmission source from the frame received by the frame receiving unit 11. For example, the address learning unit 14 stores an MAC address of the transmission source of the frame received by the frame receiving unit 11 in the learning table 21 in association with a port where the frame is received. If the MAC address of the transmission source is stored in the learning table 21, the MAC address of the transmission source is already learned. Therefore, the address learning unit 14 does not add the MAC address of the transmission source to the learning table 21.

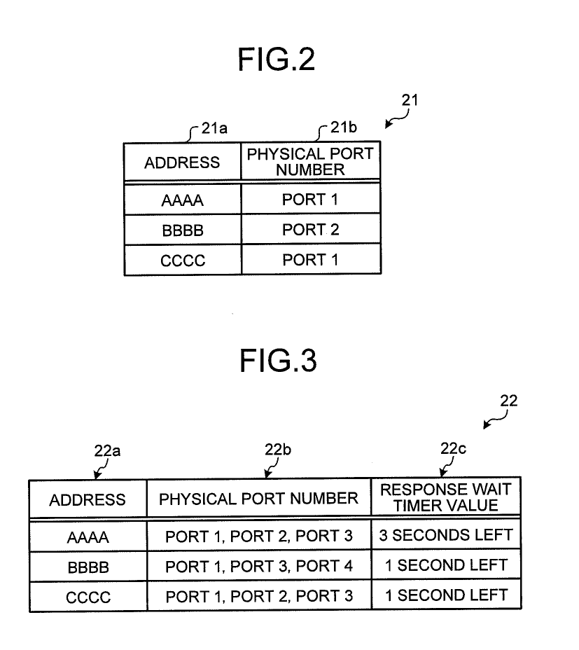

A data structure of the learning table 21 is explained with reference to FIG. 2. FIG. 2 is a diagram illustrating an example of a data structure of the learning table. As illustrated in FIG. 2, the learning table 21 stores an address 21a and a physical port number 21b in association with each other.

In the address 21a, a learned MAC address is stored. The address 21a is used when the address retrieving unit 16 explained later determines whether an address of a transmission destination of a frame is learned.

In the physical port number 21b, transmission destination information, i.e., a port number of an apparatus indicated by the address 21a associated with the physical port number 21b is stored. In other words, in the physical port number 21b, a port number is stored as transmission destination information of the network apparatus 2 identified by a MAC address of a transmission destination. The physical port number 21b is physical transmission destination information but can be virtual transmission destination information. Specifically, information concerning virtual LAN (VLAN) can be used as the transmission destination information instead of the physical port number. The physical port number 21b is transmission destination information in the case of the connection by wire but can be transmission destination information in the case of the connection by radio. In the case of the connection by radio, the transmission destination information can be, instead of the physical port number, an MAC address of an adjacent apparatus in transferring a frame.

As an example of the learning table 21, if the address 21a is “AAAA”, “port 1” is stored as the physical port number 21b.

The diverting unit 15A diverts processing from a received frame. For example, if an address of a transmission destination of a frame acquired by the address learning unit 14 is an address of the network apparatus 1, to execute an application using the frame, the diverting unit 15A passes the frame to the application unit 13. If the address of the transmission destination of the frame acquired by the address learning unit 14 is an address of a network apparatus other than the network apparatus 1, the diverting unit 15A determines that the frame is a frame indicating a transmission request or a relay frame and passes the frame to the address retrieving unit 16. If the frame acquired by the address learning unit 14 is a frame used in an inquiry request, the diverting unit 15A determines that the frame is a response to the inquiry request and passes the frame to an inquiry processing unit 171A.

The address retrieving unit 16 retrieves, concerning the frame passed from the diverting unit 15A, transmission destination information corresponding to the address of the transmission destination from the learning table 21. If the address retrieving unit 16 successfully retrieves the transmission destination information corresponding to the address of the transmission destination, the address retrieving unit 16 transmits, based on the retrieved transmission destination information, the frame passed from the diverting unit 15A via the frame transmitting unit 12. On the other hand, if the address retrieving unit 16 fails in retrieving the transmission destination information corresponding to the address of the transmission destination, the address retrieving unit 16 determines that the address of the transmission destination is not learned. To inquire about transmission destination information corresponding to the address of the transmission destination, the address retrieving unit 16 passes the frame passed from the diverting unit 15A to the address inquiring unit 17. In the above explanation, the address retrieving unit 16 retrieves, concerning the frame passed from the diverting unit 15A, transmission destination information corresponding to the address of the transmission destination from the learning table 21. However, this is nota limitation. For example, even if the frame indicating the transmission request is passed to the address retrieving unit 16 from the application unit 13, the address retrieving unit 16 can retrieve, concerning the frame, transmission destination information corresponding to the address of the transmission destination from the learning table 21.

The address inquiring unit 17 includes the inquiry processing unit 171A and a response processing unit 172. The inquiry processing unit 171A creates an inquiry frame for transmission information obtained by adding the number of hops to an address of a transmission destination determined by the address retrieving unit 16 as not learned. The “inquiry frame” means a frame used in inquiring about transmission information of the address of the transmission destination.

For example, the inquiry processing unit 171A sets a predetermined number of hops and an address of a transmission destination, which a user desires to inquire, in a user data portion of the inquiry frame. The inquiry processing unit 171A stores a response wait time for waiting for a response after transmitting the inquiry frame in the inquiry management table 22. The inquiry processing unit 171A transmits the created inquiry frame to the adjacent network apparatus 2 via the frame transmitting unit 12. If a plurality of the adjacent network apparatuses 2 are present, the inquiry processing unit 171A desirably simultaneously transmits the inquiry frame to the network apparatuses 2. This is for the purpose of reducing an inquiry time. The predetermined number of hops can be the number of the network apparatuses 2 on the network apparatus 1 side excluding a backbone functioning as a trunk line of the network. The backbone is excluded to prevent a network load from being applied by an inquiry and reduce time of the inquiry itself. However, if the entire configuration of the network is unknown, a maximum number of hops in the network can be set as the predetermined number of hops.

A data structure of the inquiry management table 22 is explained with reference to FIG. 3. FIG. 3 is a diagram illustrating an example of a data structure of the inquiry management table. As illustrated in FIG. 3, the inquiry management table 22 stores an address 22a, a physical port number 22b, and a response wait timer value 22c in association with one another.

In the address 22a, an address of a transmission destination to be inquired about is stored. In the physical port number 22b, transmission destination information, i.e., a port number to which an inquiry frame is transmitted is stored. The physical port number 22b is physical transmission destination information but can be virtual transmission destination information. Specifically, information concerning a virtual LAN (VLAN) can be used as the transmission destination information instead of the physical port number. The physical port number 22b is transmission destination information in the case of the connection by wire but can be transmission destination information in the case of the connection by radio. In the case of the connection by radio, the transmission destination information can be, instead of the physical port number, an MAC address of an adjacent apparatus in transferring a frame.

In the response wait timer value 22c, a remaining time of a response wait time is stored. Specifically, when the address inquiring unit 17 transmits an inquiry frame, the address inquiring unit 17 sets a maximum response wait time in the response wait timer value 22c, counts down the set response wait time according to the elapse of time, and sets a remaining time for waiting for a response in the response wait timer value 22c again.

As an example of the inquiry management table 22, if the address 22a is “AAAA”, the inquiry management table 22 stores “port 1, port 2, port 3” as the physical port number 22b and stores “3 seconds left” as the response wait timer value 22c. In this case, the inquiry processing unit 171A continues the inquiry using the remaining 3 seconds.

Referring back to FIG. 1, the response processing unit 172 performs response processing for an inquiry request. For example, if the response processing unit 172 acquires a response frame to the inquiry request from the diverting unit 15A before the response wait time decreases to 0, the response processing unit 172 performs processing concerning a response according to an inquiry result set in the response frame. The “response frame” means a frame used in a response to the inquiry request.

As an example, if information indicating that a transmission destination address is known is set in the inquiry result of the response frame, the response processing unit 172 transmits a frame indicating a transmission request via the frame transmitting unit 12 using a port where the response frame is received. Specifically, if the information indicating that a transmission destination address is known is set in the inquiry result of the response frame, the port where the response frame is received is transmission destination information of the transmission destination address. Therefore, the response processing unit 172 transmits the frame indicating the transmission request using a port associated with the transmission destination address stored in the learning table 21 by the address learning unit 14. If information indicating that a transmission destination address is unknown is set in the inquiry result of the response frame, the response processing unit 172 causes the inquiry processing unit 171A to create an inquiry frame added with the number of hops obtained by incrementing the number of hops set in an inquiry frame corresponding to a response by 1. The response processing unit 172 causes the inquiry processing unit 171A to transmit an inquiry request for transmission information of an address of a transmission destination again.

If the response wait time decreases to 0, the response processing unit 172 determines that a response frame may be unable to be acquired and causes the inquiry processing unit 171A to create an inquiry frame added with the number of hops obtained by incrementing the number of hops set in the inquiry frame by 1. The response processing unit 172 causes the inquiry processing unit 171A to transmit an inquiry request for transmission destination information of an address of a transmission destination again. In the processing explained above, the response processing unit 172 performs the inquiry again. However, this is not a limitation. The response processing unit 172 can abandon the inquiry.

Configuration of the Network Apparatus 2

The configuration of the network apparatus 2 is explained below. In the network apparatus 2, components same as the components of the network apparatus 1 are denoted by the same reference numerals and signs. Explanation of redundant configurations and operations of the components is omitted. The network apparatus 2 is different from the network apparatus 1 in that the diverting unit 15A is changed to a diverting unit 15B, the inquiry processing unit 171A is changed to an inquiry processing unit 171B, and a response-relay processing unit 173 is added. The network apparatus 2 and the network apparatus 1 can be network apparatuses including the same configuration by merging the functional units of the network apparatuses.

If a received frame is an inquiry frame, to inquire about a transmission destination of the frame, the diverting unit 15B passes the frame to the inquiry processing unit 171B. If the received frame is a response frame, to relay the frame, the diverting unit 15B passes the frame to the response-relay processing unit 173.

When the inquiry processing unit 171B acquires the inquiry frame from the diverting unit 15B, the inquiry processing unit 171B determines whether an address of an inquiry destination set in the acquired inquiry frame is stored in the learning table 21. If the address of the inquiry destination is not stored in the learning table 21, the inquiry processing unit 171B creates an inquiry frame anew based on the acquired inquiry frame. As an example, the inquiry processing unit 171B decrements the number of hops set in the acquired inquiry frame by 1. The inquiry processing unit 171B creates anew an inquiry frame for transmission destination information obtained by adding the decremented number of hops to the address of the inquiry destination. The inquiry processing unit 171B sets, as a transmission source address of the inquiry frame created anew, a transmission source address set in the acquired inquiry frame. This is for the purpose of causing the network apparatus 2, which relays the inquiry frame, to store the transmission source address in the learning table 21 in transmitting the inquiry frame to the network apparatus 2. The inquiry processing unit 171B transmits the inquiry frame created anew to the adjacent network apparatus 2 different from the network apparatus 2 at the transmission source of the inquiry frame acquired earlier.

If the address of the inquiry destination is stored in the learning table 21, the inquiry processing unit 171B determines that the address of the inquiry destination is learned and creates a response frame to an inquiry request. As an example, the inquiry processing unit 171B sets, in an inquiry result of the response frame, information indicating that the address of the inquiry destination is known. The inquiry processing unit 171B sets, in a destination address of the response frame, a transmission source address of the inquiry frame, i.e., an address of the network apparatus 1 at the inquiry source. The inquiry processing unit 171B sets, in the transmission source address of the response frame, the address of the inquiry destination instead of setting an address of the network apparatus 2. This is for the purpose of causing the network apparatus 2, which relays the network apparatus 1 and the network apparatus 2, to store the address of the inquiry destination in the learning table 21 in returning the response frame to the network apparatus 1 at the inquiry source. The inquiry processing unit 171B transmits the created response frame to an adjacent apparatus, i.e., the network apparatus 2 (or 1) at the transmission source of the inquiry frame.

When the response-relay processing unit 173 acquires the response frame from the diverting unit 15B, the response-relay processing unit 173 relays the acquired response frame. As an example, if the inquiry result set in the response frame is information indicating that the address of the inquiry destination is known, the response-relay processing unit 173 adds the address of the inquiry destination of the response frame to the learning table and transmits the response frame to the network apparatus 2 (or 1) at the transmission source of the inquiry frame. Processing for adding the address of the inquiry destination to the learning table can also be performed by the address learning unit 14 because the transmission source address of the response frame is the address of the inquiry destination. If the inquiry result set in the response frame is information indicating that the address of the inquiry destination is unknown, the response-relay processing unit 173 directly transmits the received response frame to the adjacent apparatus, i.e., the network apparatus 2 (or 1) at the transmission source of the inquiry frame.

Example of a Frame Format

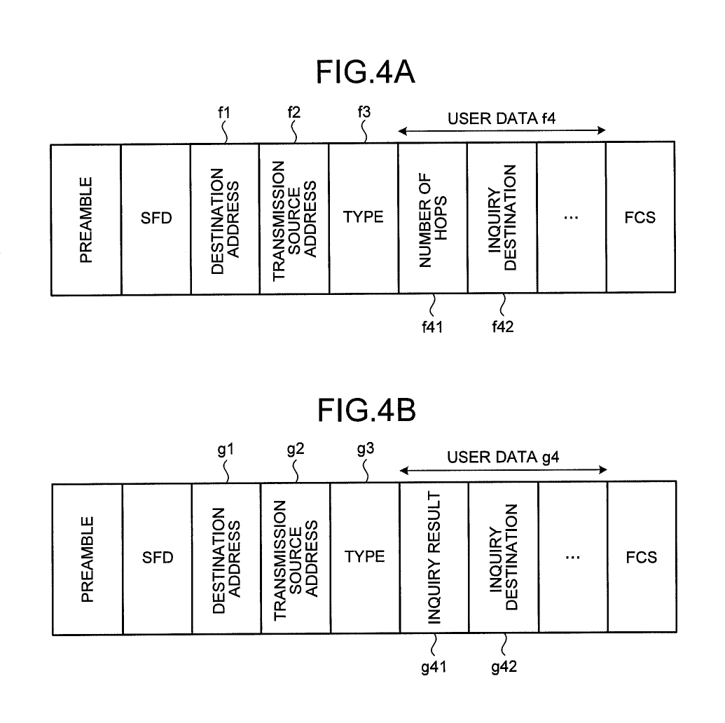

Frame formats of the inquiry frame and the response frame are explained with reference to FIGS. 4A and 4B. FIG. 4A is a diagram illustrating an example of the format of the inquiry frame. FIG. 4B is a diagram illustrating an example of the format of the response frame.

As illustrated in FIG. 4A, the inquiry frame includes a destination address f1, a transmission source address f2, a type f3, and user data f4. In the destination address f1, a multicast address receivable by only the adjacent network apparatus 2 and an unicast address for designating an MAC address of the adjacent network apparatus 2 are set. As an example of the multicast address receivable by only the adjacent network apparatus 2, an address used by a bridge protocol data unit (BPDU) employed in a spanning tree protocol (STP) is used.

In the transmission source address f2, an address of a transmission source apparatus that inquires about an address of a transmission source is set. Specifically, the address of the network apparatus 1 is set in the transmission source address f2. As explained above, the network apparatus 2, which relays the inquiry frame, directly takes over and sets the address of the network apparatus 1, which is the transmission source apparatus, in the transmission source address f2. The network apparatus 2 directly takes over the address of the network apparatus 1 in the transmission source address f2 to cause a network apparatus at a transmission destination of the network apparatus 2 to learn the address of the network apparatus 1. In the type f3, a type of a protocol used in a layer 3 is set.

The user data f4 includes the number of hops f41 and an inquiry destination f42. In the number of hops f41, the number of the network apparatuses 2 that the network apparatus 1 inquires about transmission destination information of the address of the transmission destination is set. Specifically, the number of hops f41 is the number of the network apparatuses 2 that can relay the inquiry frame to inquire about the transmission destination information of the address of the transmission destination. In the inquiry destination f42, the address of the transmission destination, the transmission destination information of which is inquired, is set.

As illustrated in FIG. 4B, the response frame includes a destination address g1, a transmission source address g2, a type g3, and user data g4. In the destination address g1, an address of a transmission source apparatus that inquires about the transmission destination address is set. Specifically, in the destination address g1, the address of the network apparatus 1 is set. As explained above, the network apparatus 2, which relays the response frame, directly takes over and sets the address of the network apparatus 1, which is the transmission source apparatus, in the destination address g1. If an inquiry result g41 explained below is information indicating that the address of the transmission destination is known, in the transmission source address g2, the inquired address of the transmission destination is set. The inquired address of the transmission destination is set in the transmission source address g2 to cause the network apparatus 2, which relays the response frame, to learn the inquired address of the transmission destination. On the other hand, if the inquiry result g41 is information indicating that the address of the transmission destination is unknown, in the transmission source address g2, the address of the network apparatus 1 is set.

The user data g4 includes the inquiry result g41 and an inquiry destination g42. In the inquiry result g41, if the transmission destination information of the address of the transmission destination is learned, information indicating that the address of the transmission destination is known in set. If the transmission destination information of the address of the transmission destination is not learned, information indicating that the address of the transmission destination is unknown is set. In the inquiry destination g42, as in the inquiry destination f42 of the inquiry frame, the inquired address of the transmission destination is set.

Procedure of Address Inquiry (an Inquiry Source)

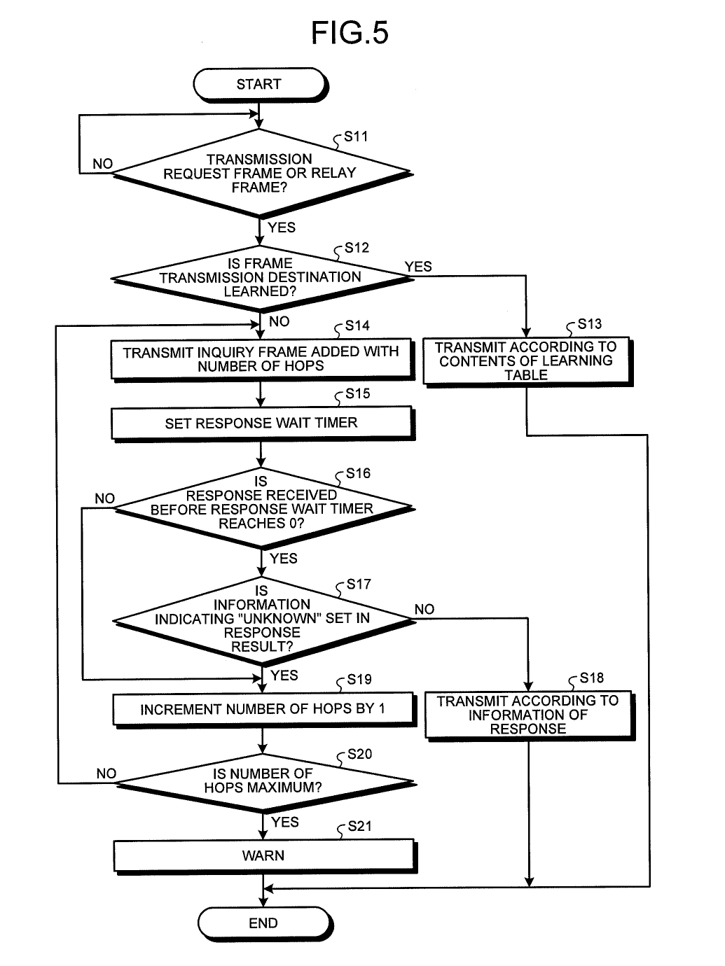

A procedure of address inquiry in which the network apparatus 1, which is the inquiry source, inquires about an address of a transmission destination of a frame is explained with reference to FIG. 5. FIG. 5 is a flowchart for explaining an address inquiry (inquiry source) procedure according to this embodiment. In the following explanation, it is assumed that the frame receiving unit 11 receives a frame indicating a transmission request or a relay frame for relaying the frame and the diverting unit 15A passes the received frame to the address retrieving unit 16.

First, the address retrieving unit 16 determines whether a frame indicating a transmission request or a relay frame for relaying the frame is present in a frame passed from the diverting unit 15A (step S11). If the address retrieving unit 16 determines that the frame indicating the transmission request or the relay frame is absent (No at step S11), the address retrieving unit 16 repeats the determination processing. On the other hand, if the address retrieving unit 16 determines that the frame indicating the transmission request or the relay frame is present (Yes at step S11), the address retrieving unit 16 determines, based on the learning table 21, whether an address of a transmission destination of the passed frame is learned (step S12).

If the address retrieving unit 16 determines that the address of the transmission destination of the passed frame is learned (Yes at step S12), the address retrieving unit 16 transmits the frame via the frame transmitting unit 12 according to the contents of the learning table 21 (step S13). Specifically, the address retrieving unit 16 retrieves, from the learning table 21, transmission destination information (the physical port number 21b) corresponding to the address of the transmission destination of the learning table 21 and transmits the frame from a port of the retrieved transmission destination information. The response processing unit 172 ends the address inquiry processing.

On the other hand, if the address retrieving unit 16 determines that the address of the transmission destination of the passed frame is not learned (No at step S12), the inquiry processing unit 171A creates an inquiry frame for transmission destination information obtained by adding the number of hops to the address of the transmission destination determined as not learned. The inquiry processing unit 171A transmits the created inquiry frame to the adjacent network apparatus 2 via the frame transmitting unit 12 (step S14). If a plurality of the adjacent network apparatuses 2 are present, the inquiry processing unit 171A simultaneously transmits the inquiry frame to the network apparatuses 2.

In transmitting the inquiry frame, the inquiry processing unit 171A sets a response wait timer (step S15). For example, the inquiry processing unit 171A sets a remaining time for waiting for a response (a response wait time) from the transmission of the inquiry frame in the inquiry management table 22 in association with the transmission destination information used in transmitting the inquiry frame. The inquiry processing unit 171A counts down the set response wait time according to the elapse of time and sets a remaining time for waiting for a response in the inquiry management table 22 again.

Thereafter, the response processing unit 172 determines whether a response is received before the response wait timer reaches 0 (step S16). If the response processing unit 172 determines that a response is received before the response wait timer reaches 0 (Yes at step S16), the response processing unit 172 determines whether information indicating that the transmission destination address is unknown is set in an inquiry result of a response frame (step S17). If the response processing unit 172 determines that information indicating the transmission destination address is known is set in the inquiry result of the response frame (No at step S17), the response processing unit 172 transmits a frame according to the information of the response (step S18). Specifically, the response processing unit 172 transmits a frame indicating a transmission request or a relay frame via the frame transmitting unit 12 using a port where the response frame is received. The response processing unit 172 ends the address inquiry processing.

On the other hand, if a response is not received before the response wait timer reaches 0 (No at step S16) or the information indicating that the transmission destination address is unknown is set in the inquiry result of the response frame (Yes at step S17), the response processing unit 172 shifts to step S19.

The inquiry processing unit 171A increments the number of hops set in the inquiry frame by 1 (step S19) and determines whether the incremented number of hops is a maximum number of hops set in advance (step S20). If the inquiry processing unit 171A determines that the incremented number of hops is not the maximum number of hops set in advance (No at step S20), the inquiry processing unit 171A shifts to step S14 to inquire about an address of a transmission destination again.

On the other hand, if the inquiry processing unit 171A determines that the incremented number of hops is the maximum number of hops set in advance (Yes at step S20), the inquiry processing unit 171A warns, for example, through display on a display, that the inquiry processing unit 171A fails in inquiring the address of the transmission destination (step S21). The response processing unit 172 ends the address inquiry processing.

Procedure of Address Inquiry (an Inquiry Destination)

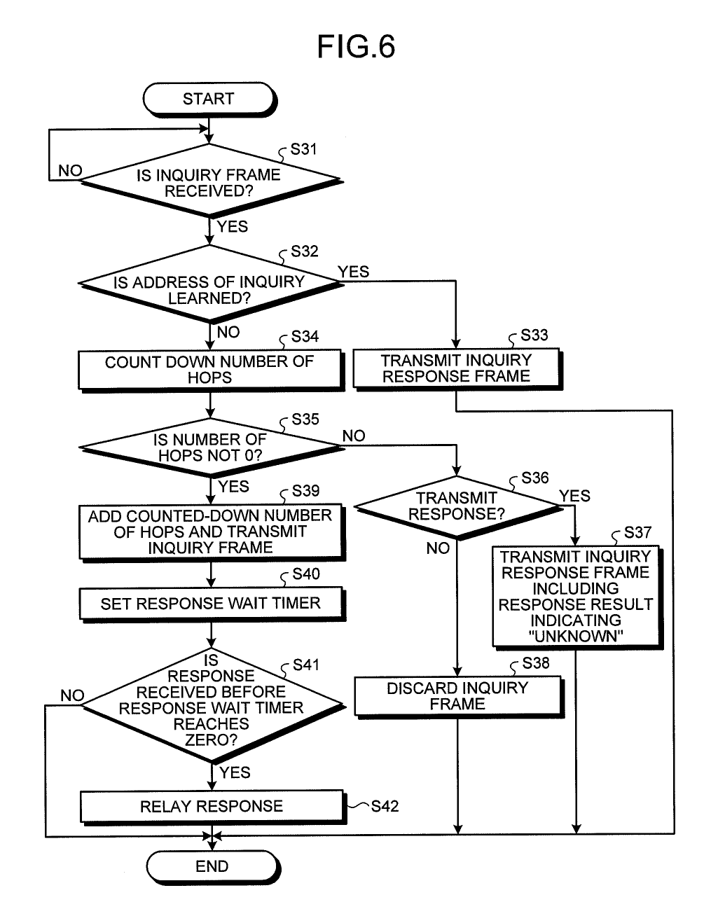

A procedure of address inquiry in which the network apparatus 2 at the inquiry destination, which receives an inquiry frame from the network apparatus 1 at the inquiry source, inquires about an address of a transmission destination is explained with reference to FIG. 6. FIG. 6 is a flowchart for explaining an address inquiry (inquiry destination) procedure according to this embodiment.

First, the diverting unit 15B determines whether the frame received by the frame receiving unit 11 is an inquiry frame (step S31). If the diverting unit 15B determines that the frame is not the inquiry frame (No at step S31), the diverting unit 15B repeats the determination processing. On the other hand, if the diverting unit 15B determines that the frame is the inquiry frame (Yes at step S31), the inquiry processing unit 171B determines whether an address of an inquiry destination of the inquiry frame passed from the diverting unit 15B is learned (step S32). The inquiry processing unit 171B determines, based on the learning table 21, whether the address of the inquiry destination is learned.

If the inquiry processing unit 171B determines that the address of the inquiry destination is learned (Yes at step S32), the inquiry processing unit 171B creates a response frame to an inquiry request. The inquiry processing unit 171B transmits the created response frame via the frame transmitting unit 12 (step S33). The inquiry processing unit 171B ends the address inquiry processing for the network apparatus 2 at the inquiry destination.

On the other hand, if the inquiry processing unit 171B determines that the address of the inquiry destination is not learned (No at step S32), the inquiry processing unit 171B counts down the number of hops set in an inquiry frame related to the inquiry request (step S34). The inquiry processing unit 171B determines whether the counted-down number of hops is not 0 (step S35). If the inquiry processing unit 171B determines that the counted-down number of hops is 0 (No at step S35), the inquiry processing unit 171B may be unable to inquire the following network apparatus 2 about the address of the transmission destination. Therefore, the inquiry processing unit 171B determines whether the response frame is transmitted (step S36). If the inquiry processing unit 171B determines that the response frame is not transmitted (No at step S36), the inquiry processing unit 171B discards the inquiry frame (step S38). The inquiry processing unit 171B ends the address inquiry processing for the network apparatus 2 at the inquiry destination.

On the other hand, if the inquiry processing unit 171B determines that the response frame is transmitted (Yes at step S36), the inquiry processing unit 171B creates a response frame to the inquiry in which a response result indicating that the transmission destination address is unknown is set in an inquiry result. The inquiry processing unit 171B transmits the created response frame to the network apparatus 2 (or 1) at the transmission source of the inquiry frame (step S37). The inquiry processing unit 171B ends the address inquiry processing for the network apparatus 2 at the inquiry destination.

On the other hand, if the inquiry processing unit 171B determines that the counted-down number of hops is not 0 (Yes at step S35), the inquiry processing unit 171B creates anew an inquiry frame for transmission destination information obtained by adding the counted-down number of hops. The inquiry processing unit 171B transmits the inquiry frame created anew to the adjacent network apparatus 2 different from the network apparatus 2 at the transmission source of the inquiry frame acquired earlier (step S39).

In transmitting the inquiry frame created anew, the inquiry processing unit 171B sets a response wait timer (step S40). For example, the inquiry processing unit 171B sets a remaining time for waiting for a response (a response wait time) from the transmission of the inquiry frame in the inquiry management table 22 in association with the transmission destination information used in transmitting the inquiry frame. The inquiry processing unit 171B counts down the set response wait time according to the elapse of time and sets a remaining time for waiting for a response in the inquiry management table 22 again.

Thereafter, the response-relay processing unit 173 determines whether a response to the transmitted inquiry frame is received before the response wait timer reaches 0 (step S41). If the response-relay processing unit 173 determines that a response to the transmitted inquiry frame is not received (No at step S41), the response-relay processing unit 173 ends the processing.

On the other hand, if the response-relay processing unit 173 determines that a response to the transmitted inquiry frame is received (Yes at step S41), the response-relay processing unit 173 relays a response frame related to the response to the network apparatus 2 (or 1) at the transmission source of the inquiry frame (step S42). The response-relay processing unit 173 ends the address inquiry processing for the network apparatus 2 at the inquiry destination.

Specific Examples of the Frame Flows

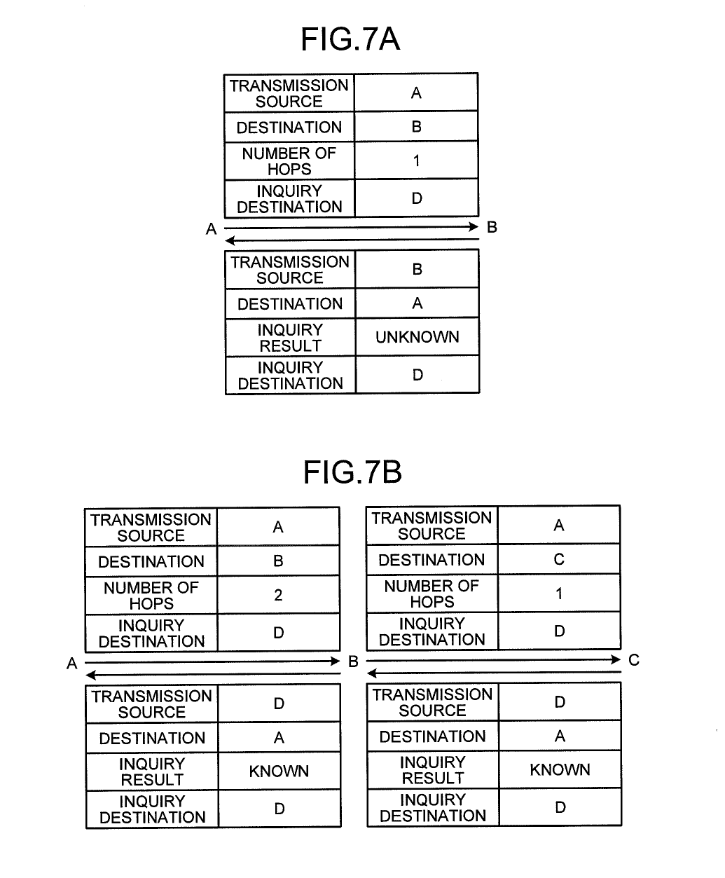

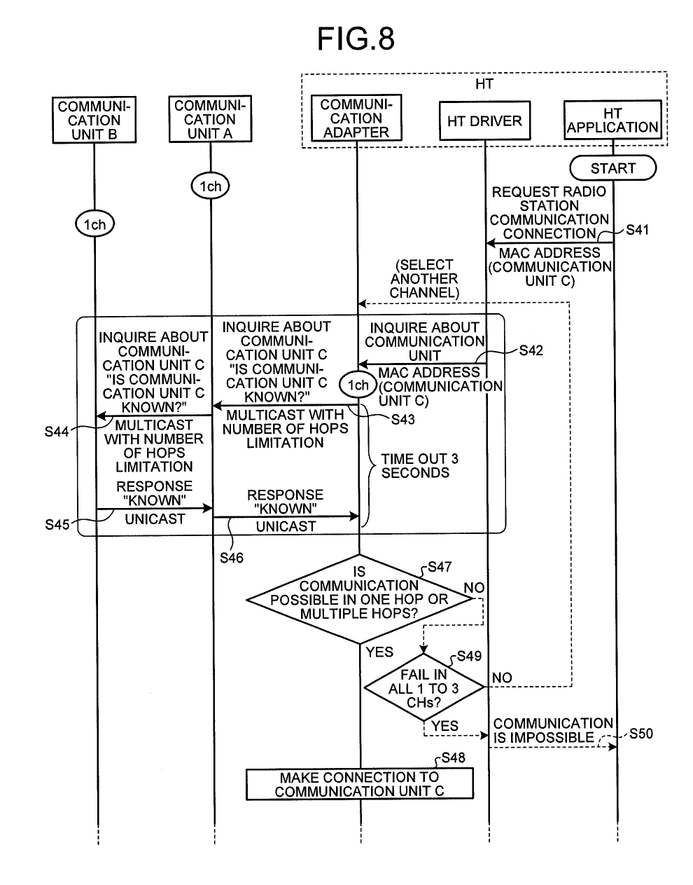

Specific examples of the frame flows of the inquiry frame and the response frame are explained with reference to FIGS. 7A and 7B. FIG. 7A is a diagram for explaining a specific example of a frame flow of a frame exchanged when the number of hops is 1. FIG. 7B is a diagram for explaining a specific example of a frame flow of a frame exchanged when the number of hops is 2. In FIGS. 7A and 7B, it is assumed that the network apparatus 1 having an address “A” receives a frame indicating a transmission request and has not learned an address “D” of a transmission destination of the received frame.

As illustrated in FIG. 7A, the network apparatus 1 having the address “A” creates an inquiry frame in which the transmission source address f2 is set to “A”, the destination address f1 is set to “B”, the number of hops f41 is set to “1”, and the inquiry destination f42 is set to “D”. The network apparatus 1 transmits the created inquiry frame to the network apparatus 2 having a destination address “B”.

The network apparatus 2 having the destination address “B” receives an inquiry frame from the network apparatus 1 having the address “A”. It is assumed that the network apparatus 2 having the destination address “B” has not learned the address “D” of the inquiry destination f42 set in the received inquiry frame. Then, because the number of hops obtained by counting down “1” set as the number of pops f41 is “0”, the network apparatus 2 may be unable to inquire the following network apparatus 2 about an address of an inquiry. It is assumed that the network apparatus 2 transmits a response frame when an address of a transmission destination is unknown. The network apparatus 2 creates a response frame in which the transmission source address g2 is set to “B”, the destination address g1 is set to “A”, the inquiry result g41 is set to “unknown”, and the inquiry destination g42 is set to “D”. The network apparatus 2 transmits the created response frame to the transmission source of the inquiry frame, i.e., the network apparatus having the address “A”. As a result, the network apparatus 1 fails in inquiry of an address of a transmission destination of a frame indicating a transmission request.

Subsequently, the network apparatus 1 having the address “A” sets the number of hops to “2” and inquires about the address “D” of the transmission destination. As illustrated in FIG. 7B, the network apparatus 1 creates an inquiry frame in which the transmission source address f2 is set to “A”, the destination address f1 is set to “B”, the number of hops f41 is set to “2”, and the inquiry destination f42 is set to “D”. The network apparatus 1 transmits the created inquiry frame to the network apparatus 2 having the destination address “B”.

The network apparatus 2 having the destination address “B” receives the inquiry frame from the network apparatus 1 having the address “A”. The network apparatus 2 having the destination address “B” has not learned the address “D” of the inquiry destination f42 set in the received inquiry frame. Therefore, the network apparatus 2 having the destination address “B” sets, in a new inquiry frame, the number of hops “1” obtained by counting down “2” set as the number of hops f41. Specifically, the network apparatus 2 having the destination address “B” creates anew an inquiry frame in which the transmission source address f2 is set to “A”, the destination address f1 is set to “C”, the number of hops f41 is set to “1”, and the inquiry destination f42 is set to “D”. The network apparatus 2 transmits the created inquiry frame to the network apparatus 2 having a destination address “C”.

The network apparatus 2 having the destination address “C” receives the inquiry frame from the network apparatus 2 having the destination address “B”. It is assumed that the network apparatus 2 having the destination address “C” has learned the address “D” of the inquiry destination f42 set in the received inquiry frame. Then, the network apparatus 2 creates a response frame in which the transmission source address g2 is set to “D”, the destination address g1 is set to “A”, the inquiry result g41 is set to “known”, and the inquiry destination g42 is set to “D”. The network apparatus 2 transmits the created response frame to the transmission source of the inquiry frame, i.e., the network apparatus 2 having the address “B”.

Further, the network apparatus 2 having the address “B” receives the response frame from the network apparatus 2 having the destination address “C”. To relay the received response frame, the network apparatus 2 having the destination address “C” transmits the response frame to the transmission source of the inquiry frame, i.e., the network apparatus 1 having the address “A”. As a result, the network apparatus 1 succeeds in the inquiry of the address “D” of the transmission destination of the frame indicating the transmission request. The network apparatus 1 can transmit the frame indicating the transmission request using a port where the response frame is received.

Use of the Address Inquiry

A sequence of communication performed when the address inquiry according to this embodiment is used for a handy terminal (HT) is explained with reference to FIG. 8. FIG. 8 is a diagram for explaining the sequence of communication performed when the address inquiry according to the embodiment is used for the HT. The HT means a data collection terminal and is, for example, a terminal that measures electric terminal. However, this is not a limitation.

In an example illustrated in FIG. 8, a sequence in connecting the HT to a communication unit C functioning as a radio station is illustrated. An application of the HT requests an HT driver to perform communication connection to the communication unit C functioning as the radio station (step S41). At this point, the application of the HT requests radio station communication connection using an MAC address of the communication unit C.

The HT driver inquires a communication adapter about the MAC address of the communication unit C (step S42). It is assumed that the communication adapter has not learned the MAC address of the communication unit C. Then, the communication adapter selects one channel (ch) and inquires a communication unit A about the selected 1 ch about the communication unit C (step S43). For example, the communication adapter transmits an inquiry frame to the communication unit A in multicast with a number of hops limitation in which the number of hops is set to “2”. The communication adapter sets 3 seconds in the response wait timer.

If the communication unit A does not know the MAC address of the communication unit C, the communication unit A inquires the communication unit B about the communication unit C (step S44). For example, if the number of hops of the inquiry frame transmitted from the communication adapter is “2”, the communication unit A transmits the inquiry frame to the communication unit B in multicast with a number of hops limitation in which “1” obtained by counting down “2” by 1 is set as the number of hops.

If the communication unit B knows the MAC address of the communication unit C, the communication unit B transmits a response frame in which an inquiry result is set to “known” to the communication unit A (step S45). For example, the communication unit B transmits the response frame to the communication unit A in unicast.

Further, the communication unit A relays the response frame transmitted from the communication unit B and transmits the response frame to the communication adapter, for example, in unicast (step S46). The communication adapter determines whether communication is possible in one hop or multiple hops (step S47). In the example illustrated in FIG. 8, within 3 seconds set in the response wait timer, the communication adapter receives, in two hops, information indicating that the communication unit C is known. Therefore, the communication adapter determines that communication is possible in multiple hops (Yes at step S47). The communication adapter is connected to the communication unit C (step S48) and becomes capable of performing communication.

If the communication adapter determines that communication is not possible in one hop or multiple hops (No at step S47), the communication adapter determines whether the communication adapter fails in the inquiry in all of 1 ch to 3 ch (step S49). If the communication adapter determines that the communication adapter does not fail in the inquiry in all of 1 ch to 3 ch (No at step S49), the communication adapter selects another channel and performs inquiry in the selected channel. On the other hand, if the communication adapter determines that the communication adapter fails in the inquiry in all of 1 ch to 3 ch (Yes at step S49), the communication adapter responds to the application that the connection to the communication unit C is difficult (step S50).

Effects of the Embodiment

According to the embodiment explained above, if transmission destination information associated with an address of a transmission destination of a detected frame indicating a transmission request is not learned, the inquiry processing unit 171A adds, to an inquiry request, the number of hops indicating the number of nodes that the inquiry processing unit 171A inquires about the transmission destination information. The inquiry processing unit 171A transmits the inquiry request added with the predetermined number of hops to an adjacent node. The response processing unit 172 transmits, based on response information to the inquiry request, a frame indicating a transmission request. With such a configuration, the inquiry processing unit 171A inquires only nodes equivalent to the number of hops at the maximum about the transmission destination information associated with the address of the transmission destination of the frame indicating the transmission request. As a result, the inquiry processing unit 171A does not cause traffic unnecessary for the network. Therefore, it is possible to reduce traffic and the likelihood of wiretapping due to packet capture or the like decreases.

According to the embodiment, the inquiry processing unit 171A sets the predetermined number of hops in a user data portion of the frame indicating the transmission request. With such a configuration, the inquiry processing unit 171A can easily apply the number of hops in the layer 2 and prevent traffic unnecessary for the traffic from being generated.

According to the embodiment, the inquiry processing unit 171A sets the predetermined number of hops to be the number of nodes excluding a backbone. With such a configuration, the inquiry processing unit 171A can avoid the backbone in which communication traffic is large. Therefore, it is possible to reduce a load on the network due to an inquiry. Further, the inquiry processing unit 171A can improve response speed for the inquiry.

According to the embodiment, if transmission destination information is not set in response information to an inquiry request, the inquiry processing unit 171A increments the number of hops by 1. The inquiry processing unit 171A transmits again the inquiry request for the transmission destination information added with the incremented number of hops. With such a configuration, by increasing, one by one, nodes that the inquiry processing unit 171A inquires about the transmission destination information, the inquiry processing unit 171A can surely inquire about the transmission destination information while preventing a network load due to the inquiry from being applied.

According to the embodiment, the inquiry processing unit 171A can use a unicast address of an adjacent node as a destination address of an inquiry frame. With such a configuration, it is possible to inquire, rather than all adjacent nodes, only specific nodes about a transmission destination of a frame.

According to the embodiment, the inquiry processing unit 171A can use, as the destination address of the inquiry frame, a multicast address that only an adjacent node can receive. With such a configuration, even if an address of the adjacent node is unknown, it is possible to perform inquiry with the number of hops limited.

According to the embodiment, if the inquiry processing unit 171B of the network apparatus 2 has learned an address of an inquiry destination, the inquiry processing unit 171B sets an inquiry destination address in a transmission source address of a response frame and sets a transmission source address of an inquiry frame in a destination address. With such a configuration, the response-relay processing unit 173 of the network apparatus 2 that relays the response frame makes it unnecessary to process the response frame. Therefore, it is possible to perform processing not to reduce processing speed in the layer 2 that performs communication using a frame.

According to the embodiment, the inquiry processing unit 171B of the network apparatus 2 makes it possible to discard the inquiry frame without transmitting the response frame if it is determined that an address of an inquiry destination is not learned. With such a configuration, if the inquiry destination is present in a wide range and the number of nodes to which the response frame is transmitted is large, it is possible to reduce the traffic of the network.

According to this embodiment, the inquiry processing unit 171B of the network apparatus 2 makes it possible to transmit the response frame if it is determined that the address of the inquiry destination is not learned. With such a configuration, if the number of nodes of the inquiry destination is limited and the number of nodes to which the response frame is transmitted is small, it is possible to learn an inquiry result before the response wait timer times out.

According to this embodiment, the inquiry processing unit 171A waits for a response to the inquiry request for a response period to the inquiry request. With such a configuration, if excessively long time is consumed for the response to the inquiry request, the inquiry processing unit 171A can discontinue the wait for the response to the inquiry request halfway. Therefore, it is possible to efficiently carry out the following processing.

Computer Program, etc.

In the embodiment, the network apparatuses 1 and 2 perform the communication control in the layer 2 using the Ethernet. However, the network apparatuses 1 and 2 are not limited to the communication control and can perform communication control in the layer 2 using, for example, a point to point protocol (PPP) or a high-level data link control procedure (HDLC) protocol. In the case of the PPP, it is sufficient to replace the inquiry frame and the response frame with a format of an MAC frame and use a format of a PPP frame. In the case of the HDLC protocol, it is sufficient to replace the inquiry frame and the response frame with the format of the MAC frame and use a format of an HDLC frame.

The network apparatuses 1 and 2 can be realized by mounting the functions of the diverting unit 15A, the address retrieving unit 16, the address inquiring unit 17, and the like on a known information processing apparatus such as a personal computer or a work station.

The components of the apparatuses illustrated in the figures do not always need to be physically configured as illustrated in the figure. Specific forms of distribution and integration of the apparatuses are not limited to those illustrated in the figures. All or a part of the components can be functionally or physically distributed and integrated in an arbitrary unit according to various loads, states of use, and the like. For example, the inquiry processing unit 171A, the inquiry processing unit 171B, the response processing unit 172, and the response-relay processing unit 173 can be integrated as one unit. The diverting unit 15A and the diverting unit 15B can be integrated as one unit. On the other hand, the response processing unit 172 may be distributed into a first response processing unit that performs response processing when a response frame is successfully received within the response wait time and a second response processing unit that performs response processing when a response frame is not successfully received within the response wait time. The storing unit 20 including the learning table 21 and the inquiry management table 22 can be connected through the network as an external device of the network apparatus 1.

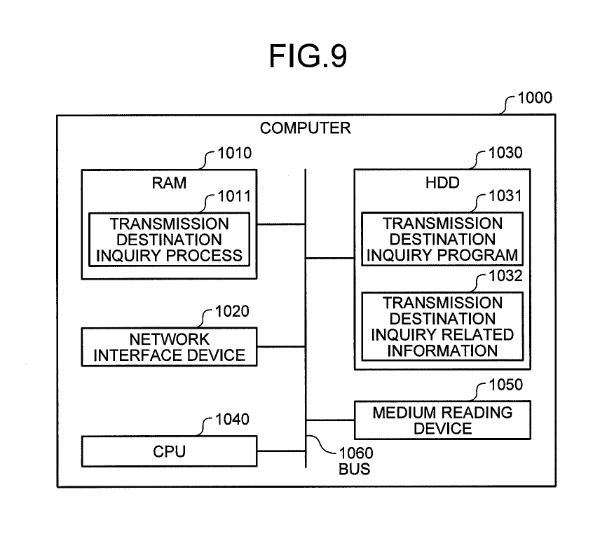

The various kinds of processing explained in the embodiment can be realized by executing computer programs prepared in advance using a computer such as a personal computer or a work station. Therefore, in the following explanation, an example of a computer that executes a transmission destination inquiry program having functions same as the functions of the network apparatus 1 illustrated in FIG. 1 is explained with reference to FIG. 9.

FIG. 9 is a diagram illustrating the computer that executes the transmission destination inquiry program. As illustrated in FIG. 9, a computer 1000 includes a random access memory (RAM) 1010, a network interface device 1020, a hard disk drive (HDD) 1030, a central processing unit (CPU) 1040, a medium reading device 1050, and a bus 1060. The RAM 1010, the network interface device 1020, the HDD 1030, the CPU 1040, and the medium reading device 1050 are connected by the bus 1060.

In the HDD 1030, a transmission destination inquiry program 1031 having functions same as the functions of the control unit 10 illustrated in FIG. 1 is stored. In the HDD 1030, transmission destination inquiry related information 1032 corresponding to the learning table 21 and the inquiry management table 22 illustrated in FIG. 1 is stored.

The CPU 1040 reads out the transmission destination inquiry program 1031 from the HDD 1030 and loads the transmission destination inquiry program 1031 to the RAM 1010, whereby the transmission destination inquiry program 1031 functions as a transmission destination inquiry process 1011. The transmission destination inquiry process 1011 loads, as appropriate, information and the like read out from the transmission destination inquiry related information 1032 to a region allocated to the transmission destination inquiry process 1011 on the RAM 1010 and executes various kinds of data processing based on the loaded data and the like.

The transmission destination inquiry program 1031 does not always have to be stored in the HDD 1030. The computer 1000 can read out and execute the transmission destination inquiry program 1031 stored in a “portable physical medium” such as a CD-ROM.

The transmission destination inquiry program 1031 can be stored in another computer (or a server) or the like connected to the computer 1000 via a public line, the Internet, a local area network (LAN), a wide area network (WAN), or the like. In this case, the computer 1000 reads out the transmission destination inquiry program 1031 from the computer or the like and executes the program.

According to the aspect of the network apparatus disclosed in this application, there is an effect that, when an address of a transmission destination is inquired in the layer 2, it is possible to realize a reduction in traffic and maintenance of security.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A network apparatus comprising:
a storing unit configured to store transmission destination information, which is used in transmitting a frame to a node, in association with an address of a node of a transmission destination;
an inquiring unit configured to transmit, when detecting a frame indicating a transmission request and transmission destination information associated with an address of a transmission destination of the detected frame is not stored in the storing unit, an inquiry request for the transmission destination information to an adjacent node, the inquiry request being added with a predetermined number of hops indicating a number of nodes to which the inquiring request is transmitted; and
a transmitting unit configured to transmit, based on response information to the inquiry request, the frame indicating the transmission request.

2. The network apparatus according to claim 1, wherein the inquiring unit sets the predetermined number of hops in a user data portion of the frame indicating the transmission request.

3. The network apparatus according to claim 1, wherein the inquiring unit sets the predetermined number of hops as a number of nodes excluding a backbone.

4. The network apparatus according to claim 1, wherein, if the transmission destination information is not set in the response information to the inquiry request, the inquiring unit increments the number of hops added to the inquiry request by 1 and transmits again the inquiry request for the transmission destination information.

5. The network apparatus according to claim 1, wherein the inquiring unit designates, in transmitting the inquiry request, a unicast address of the adjacent node as the transmission destination.

6. The network apparatus according to claim 1, wherein the inquiring unit designates, in transmitting the inquiry request, a multicast address receivable by only the adjacent node as the transmission destination.

7. The network apparatus according to claim 1, wherein the inquiring unit designates, in transmitting a response to the inquiry request, an address of an inquiry destination as a transmission source.

8. The network apparatus according to claim 1, wherein the inquiring unit transmits no response as a response to the inquiry request if the transmission destination information is not stored in the storing unit or if the number of hops of the inquiry request reaches a limit of the number of hops.

9. The network apparatus according to claim 1, wherein the inquiring unit transmits a response for notifying an inquiry failure as a response to the inquiry request if the transmission destination information is not stored in the storing unit or if the number of hops of the inquiry request reaches a limit of the number of hops.

10. The network apparatus according to claim 1, wherein the inquiring unit waits for a response to the inquiry request only in a response period to the inquiry request.

11. A network apparatus comprising:
a processor; and
a storing unit storing transmission destination information, which is used in transmitting a frame to a node, in association with an address of a node of a transmission destination, wherein the processor executes:
transmitting, when detecting a frame indicating a transmission request and transmission destination information associated with an address of a transmission destination of the detected frame is not stored in the storing unit, an inquiry request for the transmission destination information to an adjacent node, the inquiry request being added with a predetermined number of hops indicating a number of nodes to which the inquiring request is transmitted; and
transmitting, based on response information to the inquiry request, the frame indicating the transmission request.

12. A transmission destination inquiring method executed by a computer, the transmission destination inquiring method comprising:
transmitting, when detecting a frame indicating a transmission request and transmission destination information associated with an address of a transmission destination of the detected frame is not stored in a storing unit, an inquiry request for the transmission destination information to an adjacent node, the inquiry request being added with a predetermined number of hops indicating a number of nodes to which the inquiring request is transmitted, the storing unit storing the transmission destination information, which is used in transmitting a frame to a node, in association with an address of a node of a transmission destination; and
transmitting, based on response information to the inquiry request, the frame indicating the transmission request.

13. A non-transitory computer readable storage medium having stored therein a transmission destination inquiring program causing a computer to execute a process comprising:
transmitting, when detecting a frame indicating a transmission request and transmission destination information associated with an address of a transmission destination of the detected frame is not stored in a storing unit, an inquiry request for the transmission destination information to an adjacent node, the inquiry request being added with a predetermined number of hops indicating a number of nodes to which the inquiring request is transmitted, the storing unit storing the transmission destination information, which is used in transmitting a frame to a node, in association with an address of a node of a transmission destination; and
transmitting, based on response information to the inquiry request, the frame indicating the transmission request.
